(19) United States
(12) Patent Application Publication
(10) Pub. No.: US 2012/0019365 A1
(43) Pub. Date: Jan. 26, 2012

(54) SHORT-RANGE COMMUNICATION-ENABLED MOBILE DEVICE, METHOD AND RELATED SERVER ARRANGEMENT

(75) Inventors: Tuomo Tuikka, Oulu (FI); Erkki Siira, Oulu (FI); Vili Tormanen, Oulu (FI)

(73) Assignee: SOLOCEM SYSTEMS OY, Kempele (FI)

(21) Appl. No.: 13/257,784

(22) PCT Filed: Feb. 20, 2009
(86) PCT No.: PCT/IB09/00308

§ 371 Date: Sep. 20, 2011

(51) Int. Cl. H04Q 5/22; G06F 15/16; H04B 5/02

(52) U.S. Cl. 340/10.1; 709/204

(57) ABSTRACT

A mobile device for enhancing context awareness in social networking includes a processor for processing data, a memory for storing data, a wireless transceiver for wirelessly transmitting and receiving data relative to remote devices, a short-range wireless transceiver, for wirelessly transmitting and receiving data relative to remote devices equipped with a compatible short-range interface, a social contact registration logic configured to obtain information from a mobile communications device of a social contact via the short-range wireless transceiver, the information identifying the social contact and/or the mobile communications device of the social contact, a context detection logic configured to obtain, via the short-range wireless transceiver, data distinctive to and provided by a tag disposed in a location accessible via the short-range data transfer, the distinctive data being thus indicative of the current location-based context of the mobile communications device and the user thereof, and a context notification logic configured to transmit an indication of the detected location-based context to a remote entity, via the wireless transceiver in order to enable providing at least one social contact of the user of the mobile communications device with knowledge of the current context.

### FIELD OF THE INVENTION

Generally the invention relates to short-range communication such as near field communication (NFC). In particular, the invention concerns establishment of ad hoc social connections and acquisition of contextual data via the short-range communication.

### BACKGROUND

Communication falling under NFC typically refers to short-range wireless, i.e. contactless, communication following the corresponding standard(s) aimed for simple and safe communication between electronic devices. NFC communication is enabled by bringing two NFC compatible devices within a short distance, e.g. few centimeters, of one another. Contemporary applications of NFC technology are associated with different financial transactions, such as various payment and ticketing services, and simple data access, e.g. data retrieval, solutions. NFC capability may be added to a mobile terminal, a PDA (personal digital assistant), or some other portable or even hand-held device, which can be, and often is, carried along any-way. Technology-wise NFC is typically based on inductive-coupling, which reminds of the technology behind RFID (RF identification) identification tags and transponders. NFC technology is specified in a plurality of standards relative to the applicable hardware components and used data transfer methods. Standards are created, maintained and/or adopted by entities including, but not limiting to, ISO/IEC (International Organization for Standardization/International Electrotechnical Commission), ETSI (European Telecommunications Standards Institute), ECMA (European association for standardizing information and communication systems), GSMA (GSM Association), The Wireless USB Promoter Group and Wi-Fi Alliance. Large conglomerates such as Philips and Sony (e.g. FeliCa) have been active in developing NFC capable devices.

Social media applications such as Facebook, MySpace and LinkedIn have gained tremendous popularity among the Internet users since the beginning of the 2000's. The concept of establishing various online communities through creation of an up-to-date on-line user profile by a desktop or portable computing device in a preferred social networking service and subsequently inviting a number of friends or business contacts to join the service for future information sharing seems to be the most typical implementation approach depending on the focus of the service (either business-oriented or a more like a buddy list). The users belonging to the same sub-community, i.e. ‘friends’ or ‘contacts’, may often contribute to others' profiles and share thoughts, files, links, and applications via the service whereas the remaining users being not members of the same sub-community may only access limited information related thereto. The social networking solutions thus try to combine features from more traditional paper-form or electronic personal address book, calendar, blogs, and web pages into an aggregate (social) life portal for also others to use.

Current social networking sites and derivatives thereof, such as various lifestreaming or ‘life-blogging’ solutions, concentrate on the Internet as an access medium and service carrier both alike. Thereby, use of such sites requires accessing a web service for practically any related task including signing in, creating and maintaining a profile, adding new friends/contacts to the account, uploading and updating profile related information such as photos, messages, status/context information and applications. The access is typically manual in a sense that the user logs in the system and configures the account step-by-step until the next visit, although certain life-streaming applications such as Tumblr or Lifestre.as can be configured to maintain a user's life profile up-to-date by automated, e.g. timed, information retrieval from a number of particularly selected web pages such as blog(s), microblog(s) and social networking sites e.g. by RSS (Really Simple Syndication). Typically the information content of such sources is maintained manually, i.e. a blog owner types in the articles via the keyboard or clicks a certain applet-related symbol in a browser to send a link of the current web page directly into his blog, etc.

Thus the solutions for acquiring, storing, mapping and analyzing user's actions in the associated context for adoption by a social networking and/or lifestreaming service are about to reach a point where a vast amount of events, some of more relevance than the rest, can indeed be tracked and supplied to a web site through which the service is operated. Various context data such as location data, obtained via cell-ID monitoring and/or GPS, may be attached to the reported events such that either a lifestream or other type of activity log can be ultimately constructed by the service on the basis of the event information.

For instance, publication WO2008118119 discloses a method, apparatus and system of mobile content creation, sharing, and commerce in a geo-spatial environment. It is proposed that positioning data of a mobile device is transmitted to a remote server at a periodic interval, automatically generating in the mobile device, in response to the server, a present location profile associated with a present geographic location of the mobile device. A map module in the remote server may generate a map view of the geo-spatial social network to locate the presently perceived physical location of the user of the mobile device. The geo-spatial social network may be a communication network for interaction between the users in the geo-spatial environment and/or may be simplified by the server to operate through a mobile communication infrastructure. Sense data (e.g., the textual data, the visual data, the auditory data, the video data, and/or the audio-visual data) in the present location profile as perceived by the user of the mobile device may be automatically attached when the user selects a capture function in the present location profile. A triangulation algorithm (e.g., a global positioning algorithm and/or a radio algorithm) may be applied to generate a compass view in the mobile device that represents each adjacent profile as being in front of, behind, to the left of, and to the right of the mobile device. Moreover, a classified view of purchasable items at homes near the present geographic location of the mobile device may be generated when residents of the homes market goods they no longer want in the geo-spatial social network associated with the server. Also, an announcement of the residents may be published to be shared with mobile devices around homes of the residents who publish the announcement. Groups may be formed between the users of the mobile device and other mobile and/or non-mobile users of the geo-spatial social network based on shared interests.

### SUMMARY OF THE INVENTION

The objective is to provide an innovative alternative for social contacts network formation and management overcoming at least some of the drawbacks evident in the prior art arrangements.

The objective is met by a mobile communications device, a system and a method in accordance with the present invention. The mobile communications device comprises a short-range wireless transceiver, such as a near field communication (NFC) transceiver targeted towards peer-to-peer radio link-type communication. The device further comprises at least one supplementary wireless communications adapter, which preferably supports longer range and/or higher data rates than the short-range transceiver. Non-limiting examples of the further adapters include a GSM (Global System for Mobile Communications) transceiver, a GPRS (General Packet Radio Service) transceiver, an EDGE (Enhanced Data rates for Global Evolution) transceiver, a UMTS (Universal Mobile Telecommunications System) transceiver, a WCDMA (wideband code division multiple access) transceiver, a PDC (Personal Digital Cellular) transceiver, a PHS (Personal Handy-phone System) transceiver, and a WLAN (Wireless LAN, wireless local area network) transceiver. The adapter may be such that it is configured to co-operate with a predetermined communications network (infrastructure) such as the adapters listed above. The network may further connect to other networks and provide versatile switching means for establishing circuit switched and/or packet switched connections between the two end points. In addition/alternatively the device may comprise a supplementary wireless adapter such as a Bluetooth adapter meant for peer-to-peer communication and piconet/scatternet use. In addition, the device may comprise interface(s) for wired connections and associated communication relative to external entities, such as an USB (Universal Serial Bus) interface, Ethernet interface, or a Firewire interface.

The mobile communications device may be brought, by the user thereof, into the vicinity, i.e. within the range of the short-range wireless transceiver, of a remote device such as another mobile communications device or a tag also including a compatible short-range transceiver (or in the case of a tag, at least a transmitter) so that the mobile communications device may receive data transmitted by the remote device over the established peer-to-peer (P2P) connection for, in the case of a remote mobile communications device, obtaining a record of the associated ‘ad hoc’ social contact and bond between the users via the communicating devices (i.e. the other device creates substantially a similar record), or, in the case of a tag, for context determination and/or obtaining a contact record relative to the tag owner.

The mobile communications device may wirelessly send and address context notifications to remote parties, such as a server arrangement according to the present invention (for storage and further distribution), or directly to other mobile communications devices, e.g. the ones carried by the social contacts of the user, optionally routed via a network infrastructure. In some embodiments also social contact information may be exchanged between two mobile communications devices e.g. in relation to a contact being not a party of the particular communication session and/or addressed to a service management server for storage, for providing a routing aid relative to context notifications (received indication of a context change may be then automatically forwarded to the devices of the social contacts of the particular user without a need to manually input new contact in the server database), and optionally for distribution purposes.

Transmission and reception of various data, such as context notifications and/or social contact information, relative to remote entities, such as other mobile communications devices and/or server(s), may thus generally take place directly between the devices or via intermediate network infrastructure(s).

Accordingly, in an aspect of the present invention a mobile communications device for enhancing context awareness in social networking comprises a processor for processing data, a memory for storing data, a wireless transceiver for wirelessly transmitting and receiving data relative to remote devices, a short-range wireless transceiver, such as an NFC transceiver, for wirelessly transmitting and receiving data relative to remote devices equipped with a compatible short-range transmitter or transceiver, such as another mobile communications device or a tag, respectively, the device further comprising
a social contact registration logic configured to obtain information from a mobile communications device of a social contact via the short-range wireless transceiver, said information identifying the social contact and/or the mobile communications device of the social contact, and further configured to store said information in the memory,
a context detection logic configured to obtain, via the short-range wireless transceiver, data distinctive to and provided by a tag disposed in a location accessible by the user of the mobile communications device in light of the range of short-range data transfer, said distinctive data being thus indicative of the current location-based context of the mobile communications device and the user thereof, and further configured to store said data in the memory, and
a context notification logic configured to transmit an indication of the detected location-based context, such as at least part of said obtained data, to a remote entity, such as a server or another mobile communications device, via the wireless transceiver in order to enable providing, by access to said indication, at least one social contact of the user of the mobile communications device with knowledge of the current context of the mobile communications device and the user thereof.

In addition to the wireless transceiver, the context notification logic may be enabled to utilize a wired interface or the short-range wireless transceiver for transferring context indications to a remote device, such as a personal computer, for storage, analysis and/or forwarding purposes.

In the case of a server representing the remote entity, access to the received indication of the detected location-based context of a mobile communications device (and user thereof) may be provided to the social contact of the device owner by forwarding the indication itself either as is or in a modified form, and/or by providing access to the server. In another scenario, the mobile communications device addresses the context indication directly to another mobile communications device, e.g. a device of a social contact, whereby the indication may be transmitted thereto locally over a peer-to-peer-connection between the devices or via intermediate devices such as a network infrastructure taking care of the routing procedure. In either case, the remote entity may send the indication further to another at least one entity, which may then forward the information to the end user or provide at least access thereto. Generally, forwarding the indication itself or a notification thereof (e.g. “the context of your social contact “X” has been updated, please contact the server for further information”) to a communications device of the contact may occur via a context-event triggered or a timed message, for instance.

Both the context detection process and the context itself are inherently location-based as the context is detected and notified as a result of interaction of a tag disposed in some location with a mobile communications device. This is the case even if the data provided by the tag does particularly indicate any location. The data stored and provided by the tag shall still be distinctive, i.e. characterizing the owner, location of the tag and/or particular event in that location, in some manner. Preferably the data provided by a single tag is made unique, i.e. there's no tags providing completely identical data to reader devices, not at least within the same potential user group. If several tags provide exactly similar data, the obtainable context resolution naturally decreases and associated level of uncertainty increases.

A user of the mobile communications device may acquire a number of tags and locate them in different places, e.g. office, home, summer cabin, car, etc. Preferably the user may (re)program the tags so as to provide user-determined data in response to the context detection logic. Alternatively, pre-coded tags may be used and disposed properly to reflect the meaning of pre-coded data. As a further, either supplementary or alternative, option third party tags, i.e. tags disposed and programmed by others, may be used.

The data provided by the tags may include geographical location-related data such as exact position information in a form of coordinates, or more blurred, implicit or relative location-related data such as status and/or event indicators (home, work, car, conference, meeting, busy, skiing, party, etc.). If the location is solely relatively indicated via a general event identifier in the tag, e.g. “Olympic Games year XXXX AD”, and even several tags may be distributed in different locations where the independent (sub-)events of the general event are held, the actual physical location of the user is not unambiguously derivable from the data provided by a tag, although it's known that he/she is visiting the ongoing Olympic Games and some of the associated, possibly geographically distributed, locations.

The used data format shall preferably follow a predetermined syntax. The data format may support numerical and/or textual information, e.g. a free text field. The location may be indicated via a separate field or with the free text field, for example. Free text field may include expressions like “John's apaitment”, “my car”, “working”, “Bar Starlight”, and “Conference on social networking on 21 Jan. 2009 in Atlanta”. For instance, the example “my car” tells that the person in question was located in his car at the time of context update, but the location of the car itself is not fixed. Further, the data format may include a tag ID field and/or a user ID field (e.g. personal name or personal code). The provided data may specifically indicate, e.g. via a predetermined code, that the tag is particularly intended for use with the present invention as various tags for various different purposes may be generally located in the environment accessible by the users of the present invention. As an optional feature, the tag may incorporate a positioning means such as a GPS receiver or cell-ID tracker functionality in connection with a cellular network chip so as to automatically update at least part of the data to be transmitted according to the sensed location. If a mobile communications device used for programming the tag contains location information (user inputted or obtained via a GPS receiver or other element), the location information may be transferred to the tag during a programming procedure. Likewise, the location information may be added to a context detection event by the mobile communications device and optionally forwarded together with the context indication.

Yet, in addition to the short-range communication means, such as the NFC transmitter/transceiver, the tag may carry a communications transceiver, a wireless and/or wired one, for communicating with the mobile communications device or other entities, such as a predetermined network or computer device, through a communications technology different from the short-range NFC or corresponding technique, optionally advantageously providing a benefit over the NFC e.g. via higher band-width and/or greater range. In one embodiment, after initial interaction between the mobile communications device and the tag to occur using NFC or some other feasible wireless short-range technology, further data transfer takes place using the additional transceiver following some other wireless communications technique, e.g. WLAN or Bluetooth, also supported by the mobile device.

Accordingly, the context indications may include both spatial and temporal aspects, as well as various messages and notices left by the tag owners, as also the time of contact between the mobile communications device and tag may be recorded and transmitted depending on the embodiment.

In a preferred supplementary embodiment the mobile communications device, e.g. the context notification logic thereof, is also configured to receive indications of context updates relative to the current context of one or more remote devices and therefore implicitly of the users thereof, i.e. context of social contacts registered by e.g. the social contact registration logic. The indications may be received via the wireless transceiver, the short-range wireless transceiver and/or an interface for wired communication, as sent by a remote entity such as a service management server or another mobile communications device for insertion in a local database of social contacts (e.g. as current context of a contact) and/or for notifying the local user of a social contact's context update event applying visual (e.g. message shown on a display), auditory (e.g. sound reproduction via a loudspeaker) and/or tactile feedback (e.g. vibration by a vibration unit), for instance. When the communication takes place through a communications network infrastructure, there may naturally be a number of intermediate entities between the remote entity (e.g. service management server or another mobile communications device) and the mobile communications device, such as base stations, switches, gateways and/or intermediate networks.

In one embodiment, all or some (e.g. near-by and/or recently active according to a predetermined criterion) social contacts may be listed on the display of a mobile communications device or some other device having access to that information, such as a computer device having access to the server arrangement of the present invention or a further entity connected thereto (e.g. Facebook™). Together with the identifiers of the social contacts also their current context may be visualized. Location information obtained via a tag may be visualized as a marker on a map element, for instance. Optionally, also mating events (i.e. mutual new contact registration between two parties in accordance with the present invention) may be either substantially immediately after the registration or e.g. conditionally later visualized on the map display (e.g. via text shown “New contact between John and Mary” when highlighting a corresponding marker on the map), optionally for a predetermined time, provided that such mating information is provided to the visualizing entity, such as the server or a common contact of both parties that just registered their social relationship. Different filtering rules may be applied to the visualization, such as contact-type information-based filter (e.g. private vs. business contacts), when available in the stored social contact information.

The social contact information may comprise remote device-specific information, e.g. device-ID information, pertaining to the mobile communications device of the social contact and/or device user-specific information, e.g. personal/user name or other ID, thus more explicitly relating to the social contact himself/herself

In one supplementary embodiment two mobile communications devices may register relative to each other even if they have previously already done so. As a result, social contact information may still be exchanged and updated, when applicable, and/or context optionally updated such that a device having an older context detection entry adopts the context of the device with temporally more recent context detection event.

In one embodiment, the mobile communications device may further comprise a social contact notification logic configured to transmit at least part of the stored social contact information to a remote entity, such as a service management server of the system, another mobile communications device (own or of a contact) or a computer device (e.g. a personal computer), via the short-range wireless transceiver, e.g. an NFC transceiver, or the wireless transceiver, e.g. an UMTS transceiver. Once again, when the communication takes place through a communications network infrastructure, there may be a number of intermediate entities, such as base stations, switches, gateways and/or intermediate networks until the at least part of the social contact information reaches the intended recipient, i.e. the remote entity. The remote entity, when representing a server, may then forward at least part of the received data to a further entity such as said another mobile communications device or another server for exploitation, distribution and/or visualization. For example, the remote entity may be a service management entity (server) storing at least part of the social contact databases relative to a number of mobile communications device users with optional supplementary information and forwarding (routing) context notifications between the users the social contact information of which is available at the server and between which a recorded social bond exists.

The further entity may belong to a more general social networking or lifestreaming service, such as Facebook™, capable of integrating data from a plurality of sources. When the remote entity is another mobile communications device, the users may exchange contact information directly between them. In an alternative or supplementary embodiment, such contact notification logic and/or the remote entity, when forwarding data, may take advantage of an interface for wired communication, when available, for transferring the at least part of the stored social information as described above. For example, social contacts data may be transferred to a wired network-connectable local computer optionally including a local social contacts management application.

In one, either supplementary or alternative, embodiment the mobile electronic device, e.g. the social contact notification logic thereof, may be correspondingly configured to receive contact information, via the wireless transceiver, short-range wireless transceiver and/or an interface for wired communication, from a remote entity such as a service management server for insertion in a local database of social contacts. Such contact information may have been created externally, i.e. outside the mobile communications device. For instance, information on a social contact, which is a stored at a web-based social network service of which the user of the mobile communications device is a member, may be transferred to the local mobile database directly or via an intermediary such as the service management server. The social contacts may be initially created by the social contact registration logic of the mobile communications device or by an external entity, but contact-related information may be exchanged between the device and the entity afterwards to maintain local records both comprehensive and tenable.

Thus concerning either the transfer of social contact information or context indications, the data may be addressed directly to the final recipient(s), i.e. social contacts, by the transmitting device, or to an intermediate entity, e.g. a service management server in charge, for immediate or delayed forwarding to the final recipients according to the settings, either general or user-specific, followed by the entity.

Despite the fact that the mobile communications devices and compatible tags may, as being physically separate or at least separable devices, be either occasionally or most of the time situated far away from each other, the devices shall be brought within sufficiently close mutual distance, i.e. within range of the applied wireless short-range communications technology utilized by the devices, e.g. the NFC, when the primary social contact registration and context detection features of the present invention are to be actualized, though in certain embodiments either feature may support also manually typed in/selected or otherwise obtained input. The applicable range of e.g. NFC communication may typically differ from about direct physical contact between the devices (in which case the distance between the NFC transmitters, receivers, and/or transceivers embedded in the housings of the devices may still be greater than zero, e.g. few centimeters) to tens of centimeters or more, e.g. few meters.

Structural and/or functional elements of the mobile communications device such as the processor, the memory, the transceivers, the social contact registration logic, the context detection logic and the context notification logic are at least functionally connected together either directly or via intermediate elements in order to provide the necessary execution, storage, control, detecting, analysis, notification and data transfer capabilities for implementing the invention. The above and other features may be integrated with the device or provided as connectable accessories or modules.

In view of the foregoing, in another aspect of the present invention, a system for enhancing context awareness in social networking comprises
a number of tags to be disposed in a number of locations, respectively, each tag comprising a short-range wireless transmitter for transmitting data distinctive to and stored by the tag, and
the mobile communications device as described herein.

Further, the system may comprise a number of remote entities such as servers for storing social contact and/or context data, and/or for managing the distribution of context indications relative to the social contacts of each user.

Yet, in a further aspect a server arrangement for enhancing context awareness in social networking between a number of users comprises a processor for processing data, a memory for storing data, and a communications interface for transferring data via a communications network,

a social contact management logic for maintaining, relative to each user, a database of one or more social contacts and corresponding contact information for addressing at least one mobile communications device of the contact in view of data transfer capability,

a context management logic for obtaining and maintaining context indications provided by a mobile communications device of a user, said indications being based on data distinctive to and provided by a tag disposed in a location accessible by the user of the mobile communications device with the short-range wireless transceiver of the device, said distinctive data being thus indicative of the current location-based context of the close mobile communications device and the user thereof, said context management logic being further arranged to provide at least one entity, such as a social contact of the user of the mobile communications device and/or another server, with knowledge of the current context of the mobile communications device and thereby the user thereof.

The server arrangement may further be configured to receive social contact information from the mobile communications devices via the communications network.

Optionally, the server arrangement of the present invention may be integrated with or at least functionally connected to some other server or service like a more general network portal so that the users may access the server via a route and/or user interface they are already familiar with, for instance. Also the mobile application (at least the user interface part) may be integrated with another solution accordingly. Secondly, the server arrangement may be configured to host a number of events in view of the associated social networking on behalf of the event organizer (e.g. a conference organizer), optionally with a tailored portal and/or mobile application for each event. Correspondingly, more permanent exclusive and/or tailored social-networking service in accordance with the present invention may be provided to various service providers such as restaurants and companies, optionally with tailored tools for using (e.g. special mobile application) and/or managing (e.g. server access tool) each particular service.

It is naturally theoretically possible that a person other than the one registered in the service is utilizing and carrying a mobile communications device of the registered user, whereupon monitoring the context of the device does not really reflect the location-based context of the registered user but the aforesaid person instead; these cases are presumably still rather seldom and preventable by e.g. occasional user-specific service password queries (via the mobile communications device as triggered by the device itself or the server remotely) the failure of which prevents context updates until a next successful password entry.

Still, in a further aspect a method for enhancing context awareness in social net-working, comprises
obtaining a mobile communications device comprising a wireless transceiver for wirelessly transmitting and receiving data relative to remote devices and a short-range wireless transceiver, such as an NFC transceiver, for wirelessly transmitting and receiving data relative to remote devices equipped with a compatible short-range transmitter or transceiver, such as a mobile communications device or a remote tag, respectively,
establishing a social contact by information received from a remote mobile communications device of a social contact via the short-range wireless transceiver, said information identifying the social contact and/or the remote mobile communications device of the social contact,
detecting a current context by obtaining, via the short-range wireless transceiver, data distinctive to and stored by a tag disposed in a location accessible by the user of the mobile communications device in light of the range of short-range data transfer, said distinctive data being thus indicative of the current location-based context of the close mobile communications device and the user thereof, and
transmitting an indication of the detected location-based context, such as at least part of said obtained data, to a remote entity, such as a server or another mobile communications device, via the wireless transceiver in order to enable providing, by access to said indication, at least one social contact of the user of the mobile communications device with knowledge of the current context of the mobile communications device and the user thereof.

The method may further comprise obtaining a number of tags comprising a short-range wireless transmitter for transmitting data distinctive to and stored by the tag, and disposing the tags in a number of locations respectively. The data may be fixedly (e.g. by the factory or by retailer) pre-programmed or user-editable via the short-range connection, for example. Editability may be provided, e.g. upon tag purchase, via a password/code and/or some other authentication method, which are optionally user adjustable. The data may also comprise dynamic data such as real-time data from attached sensor(s) or other elements.

The utility of the present invention arises from a plurality of issues. The invention enables maintaining an electronic log of social contacts in a natural way in conjunction with physical meetings of associated parties. Likewise, the tags distributed in the environment provide for context updates arising from tag contacts without additional hassle relating to manual context switching via the mobile device etc. Context changes may still be additionally linked to take place upon occurrences of other events such as information requests and retrievals from external sources or local device mode changes. The invention may be exploited without a service/server aspect, but the service/server aspect advantageously rationalizes and facilitates storage and distribution of social contact and/or context information. Such information may be provided to third parties such as various social networking and lifestreaming services. The invention may utilize the Internet as information distribution medium, but is not dependent on web or web-based UI's like most prior art social networking solutions.

The expression “a number of” refers herein to any positive integer starting from one (1), e.g. one, two, or three.

The expression “a plurality of” refers herein to any positive integer starting from two (2), e.g. two, three, or four.

The expression “tag” refers herein to an electronic device capable of transmitting data stored therein to the mobile communications device via a compatible short-range data transfer technology such as the NFC. The tag may comprise further interfaces and elements. It shall be construed as a functional modifier despite of the particular official appellation of any element acting as a tag in the meaning of the present invention.

In one embodiment a number of users have NFC-enabled mobile communications devices and the infrastructure includes a number of corresponding tags. The users establish social contacts with each other and update their context based on interaction with tags. Context indications arising from tag-mobile communications device interaction may be delivered to remote entities and social contacts. Tags are generally positioned by manual labor but e.g. the distribution of mobile application for providing the context-awareness and social contact database of the present invention to each mobile communications device may be done over the air.

Different embodiments of the present invention are disclosed in the dependent claims.

### BRIEF DESCRIPTION OF THE RELATED DRAWINGS

Next the invention is described in more detail with reference to the appended drawings in which

FIG. 1a illustrates one use scenario of an embodiment in accordance with the present invention.

FIG. 1b illustrates another use scenario of an embodiment in accordance with the present invention.

FIG. 1c depicts one embodiment of the present invention for establishing a new social contact via mating the associated mobile communications devices through short-range wireless communication.

FIG. 2 is an illustration of mobile communication device internals according to an embodiment of the present invention and its connectivity towards remote entities such as a network server.

FIG. 3 depicts a system in accordance of an embodiment of the present invention.

FIG. 4 visualizes the outlook of different embodiments of the tags.

FIG. 5 illustrates an example of a feasible tag data format.

FIG. 6 illustrates functions performed by a mobile communications device according to an embodiment of the present invention.

FIG. 7 illustrates functions performed by a server arrangement in accordance with an embodiment of the present invention.

FIG. 8 is a flow diagram of an embodiment of a method according to the present invention.

### DETAILED DESCRIPTION OF THE EMBODIMENTS

Reverting to the foregoing, a person may acquire a number of tags and subsequently code and dispose them in so-called everyday locations such as home, work place, car, summer cabin, favorite café, etc. to enable location-based context awareness feature of the present invention. Generally a tag may be accessible by any party having a physical access to the communication range of the utilized short-range communications technique depending on the embodiment. In more public locations and associated events such as bus stops, railway stations, restaurants, cafés, discos, night clubs, house parties, public transportation vehicles, shops, offices, recreational areas, etc. it is clear that basically anyone having a compatible mobile communications device and physical access to the (communications range of) tag may try to register with it, i.e. to obtain data from the tag, in addition to the actual tag owner. However, the access may be restricted by various means as to be delineated herein.

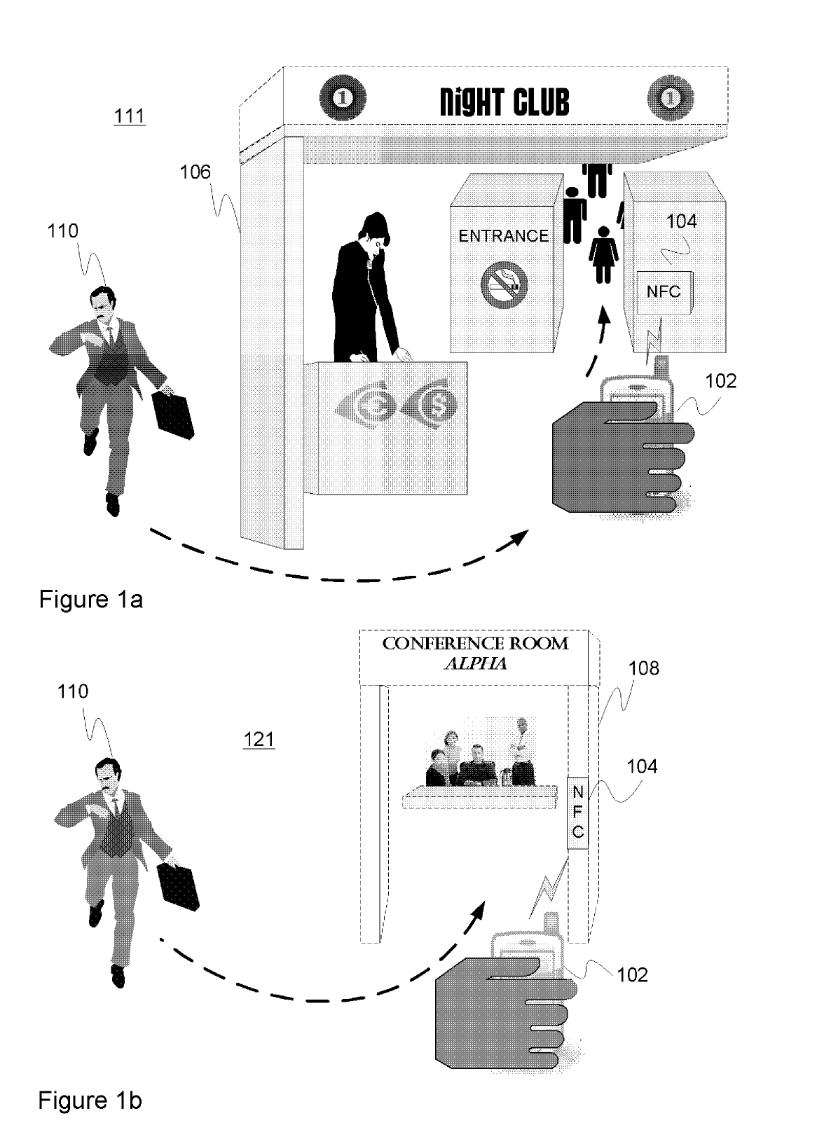

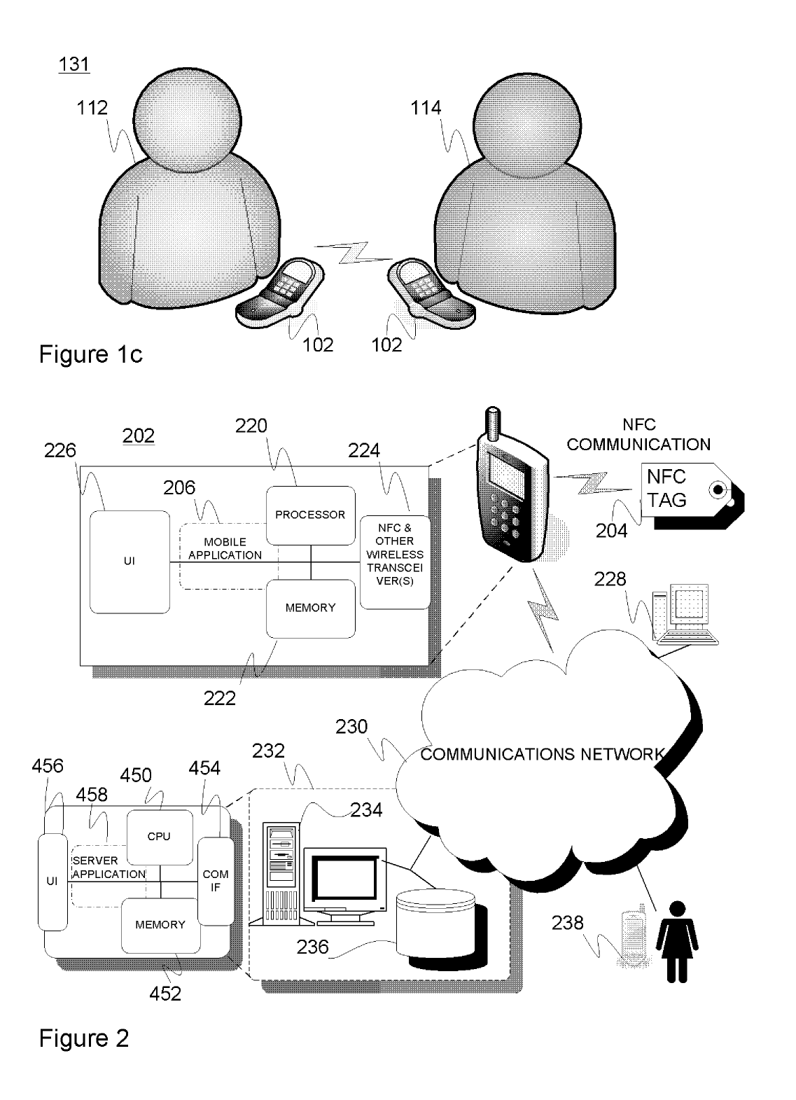

FIG. 1 illustrates one, merely exemplary, ‘free-time’ use scenario 111 of an embodiment according to the present invention. A user 110 of the mobile communications device 102 (hereinafter ‘mobile device’) adapted to implement the features of the present invention is on his way to a night club 106 where a number of NFC tags 104 have been positioned, e.g. by guest(s) and/or, most typically, the night club owner, on locations such as wall surfaces accessible the user 110 with his mobile device 102. The user 110 may then place the mobile device 102 within the communication range of tag 104 so as to obtain data therefrom. Additionally or alternatively, the mobile device 102 may be configured to transfer data, e.g. identification data relating to the mobile device and/or user 110, to the tag 104 for updating its usage log or some other reason. The tag 104 may include, in addition to the wireless short-range adapter such as an NFC transmitter or transceiver, a further data interface, such as a wired or wireless communications interface, for programming, data retrieval and/or data insertion purposes. The data provided by the tag 104 may have been pre-programmed by the night club owner/manager or some other party as deliberated hereinbefore. Optionally the data include dynamic information such as sensor data.

For example, the data may comprise at least one element selected from the group consisting of: location, temperature, time, tag owner details, message, message by the tag owner, message by a previous user of the tag, message left to one or more social contacts by the user of the tag, a discount code, an address or a link such as a hyperlink, an advertisement, a verification code or number, expiry time, tag type (e.g. work, home, travel, free-time, sports, etc.), and context event data such as location entry or location exit indicator. The aforesaid link may lead to the tag owner's (or last programmer's) web page or some other related web page, for instance.

In one embodiment one tag 104 may imply a context entry and some other a context exit such that the users 110 may upon entering and leaving a space interact with the appropriate tag 104.

In another embodiment a single tag 104 may bear different contextual meaning depending on the particular sequential phase of interaction events between a certain mobile device 102 and a certain tag 104. First interaction may be configured to imply a context entry and a subsequent interaction to context exit, for example. The associated monitoring logic may be implemented in the mobile device 102 or the tag (the tag may monitor the interactions user-specifically and adopts its output data, “context entry” or “context exit”, accordingly). As a supplementary or alternative embodiment, a tag-related event may be linked with an expiry time after which the context is not considered as up-to-date or valid anymore, for instance. The data provided by the tag 104 may include indication of an expiry time, optionally programmed by the tag owner. As a one use scenario, should a tag be provided in a restaurant, the restaurant/tag owner may program the expiry time as congruent with the closing time of the restaurant. The same analogy applies to other locations and their opening/closing hours as well. Alternatively, the mobile device 102 may configure an expiry timer for the context event, e.g. on the basis of data received such as the aforementioned data type. As a further alternative, the user 110 may determine the expiry time manually for the context. An indication of the expiry time may be forwarded to remote entities so that they can automatically alter the status of the context (e.g. valid/lapsed/last valid at xx.yy pm., etc.) accordingly without a separate dedicated notification from the mobile device 102.

In any embodiment, data provided by the tag 104 may include explicit commands, such as “update context”, “connect to”, or “show on a display”, for the mobile device 102 following a predetermined, e.g. proprietary, format understood by the mobile device 102. Alternatively or additionally, the tag data may include other information such as indicators or messages interpreted by the mobile device 102 according to rules embedded in the mobile software. Such other information may also implicitly trigger performing functions, when dictated by the rules of the mobile software. The software may be updated either wirelessly or via a wired interface.

In either above embodiment the triggered event at the mobile device 102 may include at least one element selected from the group consisting of device mode change, user profile change, remote server access, remote web page access, data transmission, data request transmission, transmission of social contact data, transmission of context indication, a voice call initiation, data reception, auditory signal reproduction, tactile such as vibratory feedback, visual message reproduction, and business card transmission. A person skilled in the art will appreciate the fact that some of the above elements overlap, such as data transmission and transmission of context indication.

Interaction between the mobile device 102 and the tag 104 may be configured to trigger immediate and/or later, optionally conditional, data transfer between the two entities in either direction also in general sense. For example, if the tag comprises a wired or wireless data interface for communicating with further remote entities such as servers, it may inform to remote entity of the interaction and optionally receive data from the entity for delivery to the mobile device 102. Likewise, the mobile device 102 may inform one or more remote entities such as servers of the interaction, whereupon the remote entities may forward related notifications to further entities.

Data transfers from and/or to the mobile device 102 relative to the tag 104 and/or other entities may be alternatively performed via the (primary) wireless transceiver thereof after initial short-range (NFC) communication.

For example, in the depicted night club scenario the remote entity may be a service management server of the present invention that optionally forwards a notification of the interaction with possible further information such as user information and associated social contacts information to a server more directly associated with the night club. The remote entity or the further entity may create an ad-hoc social network including at least some of the users 110. Specific data transmissions, such as advertisements, may be then targeted to the network members. Accordingly, as the receiving entity such as the server has thus become aware of those present in the location associated with the tag(s), it may optionally contact or “surprise” them (e.g. by discount coupons) via transmissions to the mobile devices 102. Based on the available local records concerning e.g. social contacts of the user 110 present and/or on the received information the server of the night club (or some other further entity) may initiate transmitting party invitations to one or more social contacts of the user 110 not yet arrived. If the server of the night club (or of some other entity) detects two or more users 110 present being already familiar with each other, i.e. social contacts, the server may inform these 110 users accordingly via messages (“Your friend X is here” or “Your friend Y just arrived on the scene!”) and/or it may check whether the users 110 have further common friends based on the available social contacts information and send invitations to the further common friends to visit the night club event and join up with their buddies already present. Alternatively, the remote entity such as the service management server may autonomously send party invitations or other notifications based on the social contacts of each user and e.g. the nature of the tag (e.g. entrance tag) taking part in the interaction.

Further entities such as tag owners may be provided with rights to at least some electronically available information relating to a mobile device 102 and associated user 110 registered relative to a certain tag 104. Yet, the rights may extend to the social contacts of the user 110. The scope of third party rights may be preferably determined by the user 110. The information may be provided by the mobile device 102 itself and/or by the remote entity such as a service management server.

FIG. 1b illustrates another exemplary and more work/business-oriented use scenario 121 of the present invention. The aspects of the previous use scenario are generally applicable also in this case and are not unnecessarily repeated. The user 110 is on his way to a conference room 108 and registers his mobile device 102 before the NFC tag 104 prior to entering the room 108. Such interaction between the mobile device 102 and the tag 104 may in this scenario trigger events such as listing the user 110 as a participant of the event held at the conference room 108, which may also imply creating and updating an ad-hoc social network of at least some of the participants. Data delivery such as conference material delivery may be then automatically actualized to the mobile devices 102 of the participants on the basis of context notifications provided to the sending entity, e.g. a server of the conference organizer, by the mobile devices 102 and/or a remote entity such as a service management server. Alternatively, the service management server of the present invention may host the conference on behalf of a third party such as the actual conference organizer. A related event-specific portal may be provided as well. As a further option, the server functionality of the present invention may be integrated with some other system such as a selected network service, e.g. a web-based social networking service. Instead of data delivery to the mobile device 102, the delivery may be targeted to some other target address associated with the user 110 such as an e-mail address so that the user 110 may conveniently directly access the data via an e-mail application of a device that is more suitable for exploiting the data than the mobile device 102. For instance, a laptop computer may suit wading through conference publications or other documents better than the mobile device 102 with a limited-size display, key-pad, or memory. The alternative addresses may form part of a user profile.

Still in a further embodiment (not shown), e.g. elderly care may exploit the possibilities of the present invention by disposing a number of tags 104 at homes of the elderly. After a predetermined time of non-activity relative to any such tag 104 (e.g. a tag associated with a home door or toilet door), an alarm may be given to field personnel to go and verify the physical status of the aged person.

FIG. 1c illustrates one embodiment and use scenario 131 of the present invention for establishing a new social contact via mating the associated mobile communications devices through short-range wireless communication as explained hereinbefore. Both the users 112 and 114 have a mobile device 102 of their own provided with necessary software for implementing the social contact registration logic of the present invention. The users 112, 114 have activated a feature allowing establishment of new contacts via the supported short-range wireless technology such as NFC. The users 112, 114 physically meet each other and decide to add each other as a new social contact. The mobile devices 102 are set next to each other and the social contact registration logics in both devices mutually exchange information. Consequently, a mobile viral social network associated with either user 112, 114 and mobile device 102 is expanded. From a technical standpoint one device may act as a master and the other as a slave during the communication, for example. The exchanged information may be delimited to the personal information and/or mobile device information of the users 112, 114 themselves, or data on already-existing other social contacts may be optionally transferred to a predetermined extent (e.g. mere names, aliases or other ID's) as well.

Mobile devices 102 may forward the obtained information by means of the social contact notification logic to remote entities such as a service management server, which may further distribute at least part of the information. After registering the social contact a context update relative to either device 102 (and implicitly user 112, 114) may be obtained by the other device 102 (and user 112, 114), respectively, through receiving a context notification sent by the remote entity such as a service management server, or by directly accessing the service. Alternatively, the context update may be provided by a further entity such as a web-based social networking service that receives context updates from the remote entity and forwards them or provides at least remote access to such information.

According to a supplementary embodiment, in case either user 112,114 interacts with a tag using his mobile device 102 within a predetermined time window relative to a past contact registration, also the context of the contacted device/user may be updated accordingly. For instance, this may be implemented such that the context of the contacted device/user is updated by direct communication between the devices (a device with recently updated tag context may indicate to another device during the short-range communication that the “context X was entered Y minutes ago”) or by a forced context update triggered by a remote entity such as a service management server keeping track of the social contacts of the users and context indications after noticing a context update of a first device/user a short time after it has reportedly communicated with another device/user; the context of this another device/user may be updated locally in the server database and then remotely by sending a context update instruction, e.g. in connection with context update notification relating to the first device or in a dedicated message, to the mobile software in the another device. Such optional feature may enhance context tracking in scenarios wherein some users inadvertently omit accessing the tag even if they are around.

Additionally or alternatively, when a social contact is created between two users via the associated two mobile devices 102 following an earlier tag interaction by either device within a predetermined time window, the context of the device not originally communicated with the tag may still be updated correspondingly. Again, the context update relative to the device/user not really interacted with the tag may be done via short-range wireless communication in connection with establishment of the social contact between the devices (the devices may inform each other of the most recent context update with the associated time stamp), or via a remote entity, for instance.

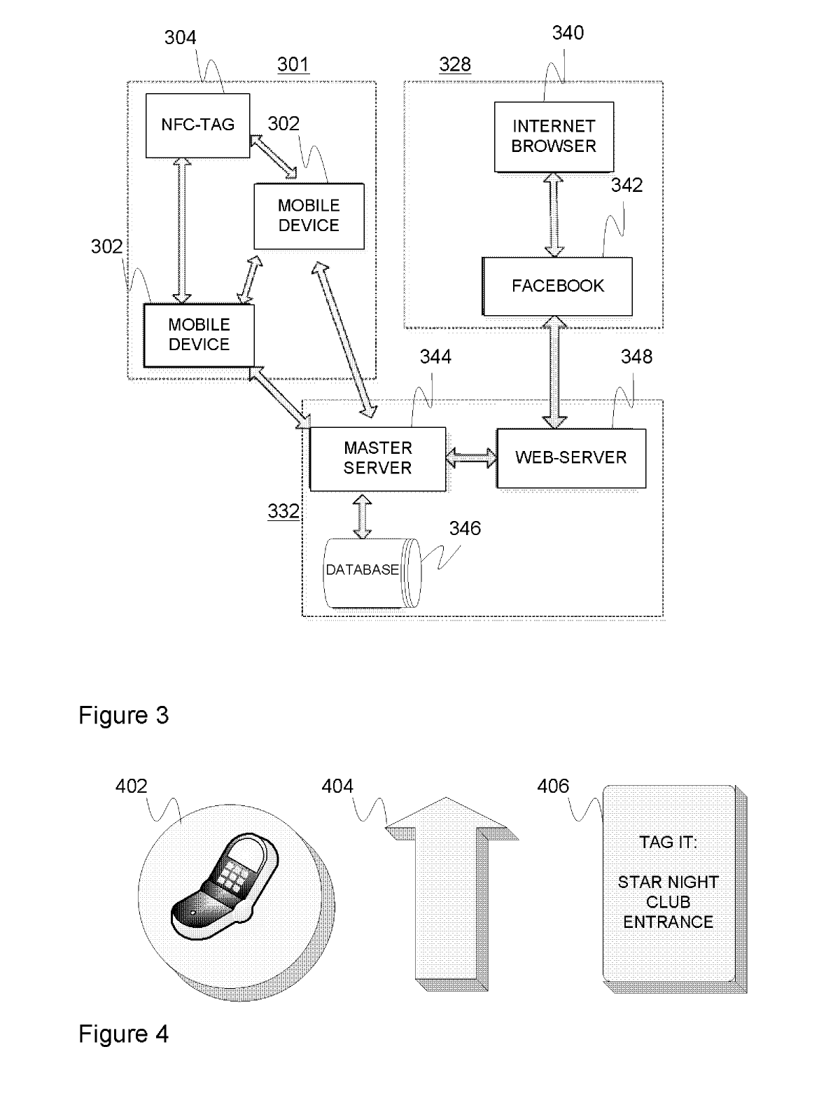

FIG. 2 is an illustration of mobile communication device internals 202 according to an embodiment of the present invention and its connectivity towards remote entities such as a network server and a tag, whereas FIG. 3 is a higher level visualization of an embodiment of the system according to the present invention including the network server in a role of a remote entity, a number of mobile devices, a number of tags and an optional further entity materialized as Facebook™ web-service functionally connected to the server.

A mobile device, such as a mobile terminal, a smart phone, or a PDA (personal digital assistant) has been provided with a short-range wireless transceiver such as an NFC transceiver or ‘NFC reader’ and software, e.g. social contacts manager application 206, for providing necessary logics for social contact registration and context detection/notification in addition to further optional tasks.

Short-range connection establishment and/or data transfer may generally follow e.g. the existing NFC standards and they may be adapted or supplemented by additional software and/or hardware such that a required level of automation and desired spectrum of features is obtained for the NFC functionality. The transfer may be initiated in response to detecting a triggering condition. The overall NFC communication process between two devices may also be executed in multiple subsequent steps, wherein the communication is first generally started between the devices during which the fulfillment of one or more conditions defines whether the communication process really ever proceeds to a stage associated with the transfer of NFC data in accordance with the present invention. The conditions may be checked by a predetermined negotiation and/or hand-shaking scenario in which the devices exchange information related to the existence of the NFC functionality and/or device/user identities, for example. As one implementation, data transfer can be made conditional also on factors such as the identity of the remote device and/or device user in addition to mere technological and spatial connectivity and compatibility. Additionally or alternatively, the devices may verify the fulfillment of other conditions for NFC data transfer. In the case of basic tags, those may, after being powered up by the electromagnetic field introduced by the mobile device 102, just send the ID's and other data thereof to the device 102 for triggering a context update and possible other functions.

Referring in particular to FIG. 2, an embodiment 202 of the mobile device 102 in accordance with the present invention may comprise at least one processor 220 such as one or more microprocessors, micro-controllers, DSP's (digital signal processor), programmable logic chips, etc. The processor 220 may comprise a plurality of co-operating processors or sub-processors. The processor 220 is configured to execute the code stored in a memory 222, which may imply processing instructions and data relative to the social contacts manager application(s) 206 and related memory areas for data elements such as the social contact information and context information elements, and optionally for other functionalities such as OS related functionalities, I/O and communications related functionalities, and/or other applications. The application(s) 206 may utilize a dedicated or a shared processor for executing the tasks thereof such as social contact registration, context detection and context notification logics. The memory 222 may be divided between one or more physical memory chips or other memory elements. The memory 222 may further refer to and include other storage media such as a preferably detachable memory card, a floppy disc, a CD-ROM, or a fixed storage medium such as a hard drive. The memory 604 may be non-volatile, e.g. ROM, and/or volatile, e.g. RAM, by nature.

The UI (user interface) 226 may comprise a display, and/or a connector to an external display or data projector, and keyboard/keypad or other applicable control input means (e.g. touch screen or voice control input, or separate keys/buttons/knobs) configured so as to provide the user of the device 202 with practicable data visualization and device control means. The UI 226 may include one or more loudspeakers and associated circuitry such as D/A converter(s) for sound output. In addition, the device 202 comprises a radio part 224 including a wireless transceiver (e.g. GSM, UMTS, WLAN) for general communications with other devices and/or a network infrastructure, and a wireless short-range transceiver, such as an NFC transceiver, for close-proximity communication with other mobile devices and tags, and optional other wireless or wired data connectivity means such as one or more radio transceivers or wired interfaces (e.g. Firewire or USB) for communication with other devices such as terminal devices, peripheral devices or network infrastructure(s). It is clear to a skilled person that the device 202 may in practice comprise numerous further functional and/or structural elements for providing various beneficial communication, processing or other features, whereupon this disclosure is not to be construed as limiting the presence of potential additional elements in any manner.

As mentioned above, the software 206 functionality may be implemented as one or several, mutually communicating, software applications executed by the processor 220. This computer software (product) may be thus provided on a carrier medium such as a memory card, a memory stick, an optical disc (e.g. CD-ROM or DVD), or some other memory carrier. The instructions required for implementing the application(s) may be stored in the carrier medium as executable or in some other, e.g. compressed, format, such that the software may be transported via the carrier medium to a target device and installed therein, e.g. in the hard disk thereof, or executed directly from the carrier medium in the target device by loading the related instructions to the memory 222 of the target device not until execution, for instance.

The tag 204 similarly comprises (not shown) at least a memory, a processing unit and a short-range transmitter or transceiver for storing and providing data to a nearby mobile device 102, 202. The tag 204 may have a further connectivity means, wired and/or wireless, for communicating with mobile devices 204 or other entities like the network infrastructure 230.

A server 234 similarly comprises a memory 452 including e.g. a database 236, a processor 450 and at least one, wired or wireless communications interface 454, for communicating, via a network infrastructure, with a number of mobile devices 202, 238 and optional further entities 228. Advantageously the server 234 comprises at least part of the social contact information available in and/or obtained via the mobile devices 202, 238 of the service users, optionally even more information, and receives at least part of the context indications for providing the mobile devices 202, 238 (and thus the users thereof) and/or further entities with context notifications and/or user behavioral data for profiling purposes. Preferably the server 234 maintains at least the most recent context indication obtained relative to a user optionally supplemented with context expiry data, e.g. expiry indicator (“context valid”/“context expired” or “remaining x minutes valid”), when applicable and available. Profiling and behavioral monitoring of users may also be performed by the server 234. Clustering and/or profiling of service users may facilitate future R&D of related devices or be used in selecting a target group for different marketing campaigns, for example. Software 458 such as one or more service management applications may be applied to control the operation of the server 234 as desired via social contact and/or context management logics, for instance. Physically the server 234 may consist of one or several at least functionally interconnected devices, e.g. function-specific servers. UI 456 may be provided for administration purposes. The mobile device 202 may preferably communicate with a communications network 230, herein referring to one or more coupled networks, via the wireless transceiver provided in addition to the short-range wireless transceiver. A remote entity 232, such as the service management server 234 and database thereof 236, may be functionally connected to the network 230 as well. One or more further entities 228 may refer to operators, advertisers, conference organizers, social networking or life-streaming services, i.e. parties that may somehow benefit from the social contact and/or context information provided by the remote entity 232 responsive to data from the mobile device 202.

The remote entity 232 may transmit (push, for example) information to further entities 228, or the further entities 228 may poll the remote entity 232, i.e. pull data therefrom. User-specific account settings stored in the remote entity 232 may define what user/mobile device-related information is visible to further entities 228 and what is not. Likewise, other one or more mobile devices 238 may be functionally connected to the network 230 for obtaining social contact and/or context information relative to the device 202 from the remote entity 232 and providing corresponding local data in return. Alternatively, the mobile devices 202, 238 may communicate without a specific server/service 232 and address data directly to each other (based on social contact information), whereupon the devices 202, 238 may communicated without or via intermediate entities, such as network infrastructure entities.

FIG. 3 is a general view of the service provided in accordance with an embodiment of the present invention. Arrows depict communication between associated entities. Referring to basic level entity 301, parties such as private mobile users or juristic persons such as different institutions or companies may acquire a number of tags 304 and preferably software, e.g. a mobile device or server executable application (the latter applicable, if tags provided with related connectivity), for managing the data content and output of the tags 304. In one potential scenario retailer stores sell packages including a number of tags and mobile software for configuring them and connecting to the service of the present invention. The tags 304 are positioned in a number of locations for future interaction with mobile devices 302 of the users visiting the associated spaces where the tags 304 reside. Information relating to each tag 304, such as location and/or owner thereof, may be registered at the service 332, which may be done by accessing the service 322 itself and providing the information, or automatically upon first context indication by a mobile device 302 relative to a new tag 304. If tags 304 are provided with network connectivity, they may also (re-)register themselves on power-up and/or after a reset or change in the settings.

Another part of the overall service is provided by the service management aspect, i.e. server arrangement, 332 forming the so-called back-end system for the solution. This is where the business logic and the data are located. The back-end server arrangement may at least functionally comprise a plurality of interconnected servers, such as a master server 344 for communication with the mobile devices 302 and an optional web-server 348 distributing data relative to further entities 328 such as various other social networking services like Facebook™ or Myspace™ 342 implemented substantially as web-sites/services accessible via web-browsers 340. Facebook™ service offers interfaces to its users for creating applications. Facebook application is a sub-website in Facebook, which users are able to create. All hosting of files is done by the user or the service provider of the user such as the service entity 332 in this particular case, and Facebook just links to the external website such as the site of the entity 332 and shows it as a part of Facebook to other users. Such services as well as the service (site) 332 of the present invention may be thus accessible via a web-browser and provide the user thereof with social contact listing (e.g. names of contacts) optionally supplemented with related context information.

In one embodiment, the service 332 provides social contact and/or context information to a third party application such as Facebook application for third party service users' exploitation. Should a party provide data from the service 332 to further entities such as Facebook service 342, the party shall be a user of both the services.

Similar information may optionally be accessed directly via the service 332. A data-base 346 in connection with a master server 344 may include social contact information and/or context information (indications). Several further entities such as an entity 328 and a location-tied other entity, such as a restaurant, may be linked via a user account such that data relating to the other entity, such as an advertisement, is provided by the service 332 for visualization through entity 328, when the associated user is in or close, according to predetermined criterion, that particular location. The service 332 may further host automatic update files for the mobile application(s) that check the newest version every time the application is launched. The launch time is preferably controlled by the user.

The mobile device 302, service 332 and/or services by further entities 328 may structure and visualize available information by exploiting a wide variety of different approaches. One preferred technique is to structure data according to a monitored event to form a view, which may be related to one or more tags and tag-triggered location-based contexts. A plurality of tags may be associated with the same event, e.g. a party in the restaurant or a certain conference, either at the mobile device 302 or service 332 by providing the necessary linkage information to these entities. In one embodiment, the tags 304 provide data, e.g. an event identifier, which enables contextual linking of two or more tags 304 together. In another embodiment such linkage information is separately transmitted to the mobile device 302 and/or the remote entity such as the service 332. E.g. textual, symbolic, and/or graphical, e.g. map, views may be exploited.

FIG. 4 illustrates the outlook of different embodiments of the tags. The dimensions of the tags may vary, but as one example the tag may have a substantially planar circular shape, with a diameter of e.g. about 3 cm, as shown at 402. One or more surfaces of the tag may contain graphics or text optionally visually indicating the purpose, nature, location and/or owner of the tag. At 404 a tag is shaped as an arrow to provide directional advice. At 406 a rectangular tag is provided with text on the front surface indicating the intended use and the associated context thereof. In one embodiment the tag is constructed from plastics and carries the necessary electronics, such as short-range transmitter, embedded thereto.

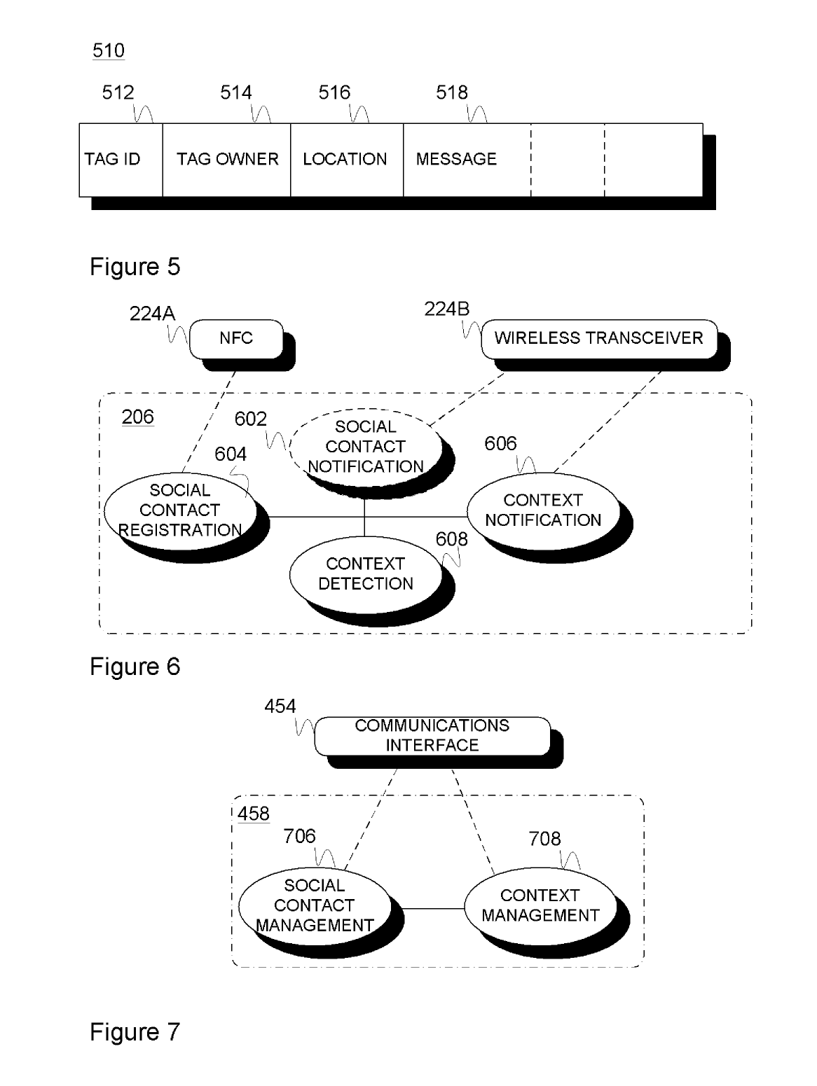

FIG. 5 illustrates an example of one generally feasible format 510 for data provided by a tag. The data provided by the tag may follow a predetermined format with one or more data fields of predetermined length such as tag ID 512, tag owner data (e.g. ID and/or social contact information) 514, location 516, and message 518.

The message field 518 may include a message by the tag owner and/or a message left by a previous user. Alternatively, one or more fields may be combined together or completely removed. The broken vertical lines indicate possible additional fields. Alternatively, the format may support dynamic data field length and/or type, whereupon the data transmitted shall contain, e.g. in a header field, necessary details of the data fields including the length thereof. The tag may include signature information such that the mobile device is capable of verifying the origin and/or owner of the tag. The memory space of the tag may support e.g. about 96 characters or more for user data depending on the type of the tag. The tags may include one or more attachment means such as an adhesive or a sticker surface, protrusion(s), and/or opening(s).

When the tag includes social contact information relative to the owner thereof or some other entity, the information may be used to create an associated social contact entry in the mobile device in addition to or instead of context update.

Optionally a mobile device may transmit social contact information regarding the user thereof (or even some other party) to the tag for storage and/or forwarding purposes.

FIG. 6 is one possible illustration of the duties of software 206, i.e. one or more software applications, arranged in the mobile device 102, 202, 302 of the present invention. The software implements at least the afore-explained social contact registration 604, social contact notification 602 (optional but advantageous entity), context notification 606 and context detection 608 logics via a number of software routines and/or software modules comprising the required instructions stored by one or more memory elements and executed by one or more processing devices in order to realize the desired functionalities, for example. In addition to or instead of software to be run on a more generic processing device, e.g. ASICs (application-specific integrated circuit) or programmable logic chips may be used to implement the corresponding functionalities. The aforesaid entities may co-operate with the short-range transceiver 224A, such as an NFC transceiver, and the wireless transceiver 224B as shown in the figure by the broken lines.

FIG. 7 is one possible illustration of the duties of software 458, i.e. one or more software applications, executed in the server arrangement of the present invention. The software implements at least the afore-explained social contact management 706 and context management 708 logics via a number of devices, software routines and/or software modules comprising the required instructions stored by one or more memory elements and executed by one or more processing devices in order to realize the desired functionalities, for example. In addition to or instead of software to be run on a more generic processing device, ASICs or programmable logic chips etc. may be used to implement the corresponding functionalities. The aforesaid entities may co-operate with the communications interface 454, such as a LAN (e.g. Ethernet) network adapter as shown in the figure by the broken lines.

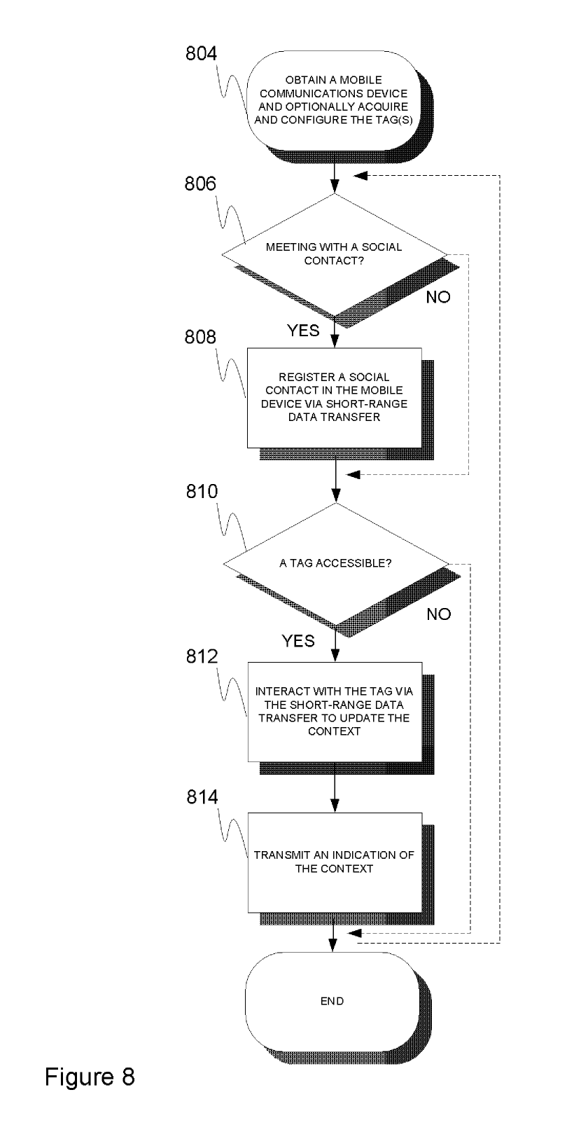

FIG. 8 is a flow diagram of an embodiment of a method according to the present invention to be performed by a mobile communications device. Upon start-up, at 804 initial actions enabling the execution of the further method steps are performed, i.e. a mobile device that supports the selected short-range communication technique and the other wireless communication technique is provided with the necessary software by the user of the device. Optionally a number of tags may be obtained and configured, i.e. programmed and positioned as pondered hereinbefore. Further, remote entities such as a service management server and optional further entities may be configured and loaded with necessary additional software, when required. At 806 it is checked whether a social contact having a compatible mobile device is present. If this is the case, the social contact is registered at 808 in the mobile device of the user, which may refer, from a standpoint of a single device, to establishing a new social contact entry or, in the case of an already existing contact, updating the social contact information and/or adopting the more recent context of the other device as mentioned herein earlier. When a tag is noticed, see 810, data is read 812 therefrom using the short-range wireless transceiver at least for the connection initiation. A context indication is transmitted to a remote entity such as a service management server at 814. A skilled reader will appreciate that phases 806, 808 and 810, 812, 814 may be repeatedly executed (see. the dotted loop-back arrow) in mutually varying order (not shown) depending on the movements of the user of the mobile device in the environment relative to tags and social contacts.

The scope of the invention can be found in the following claims. Notwithstanding the various embodiments described hereinbefore in detail, a person skilled in the art will understand that different modifications may be introduced to the explicitly disclosed solutions without diverging from the fulcrum of the present invention as set forth in this text and defined by the independent claims.

1. A mobile communications device (102, 202, 302) for enhancing context awareness in social networking comprising a processor (220) for processing data, a memory (222) for storing data, a wireless transceiver (224, 224B) for wirelessly transmitting and receiving data relative to remote devices, and a short-range wireless transceiver (224, 224A), such as an NFC (near field communication) transceiver, for wirelessly transmitting and receiving data relative to remote devices equipped with a compatible short-range communications adapter, such as a mobile communications device or a tag, said device further comprising
a social contact registration logic (206, 604) configured to obtain information from a mobile communications device of a social contact via the short-range wireless transceiver, said information identifying the social contact and/or the mobile communications device of the social contact, and further configured to store said information in the memory,
a context detection logic (206, 608) configured to obtain, via the short-range wireless transceiver, data distinctive to and provided by a tag disposed in a location accessible by the user of the mobile communications device in light of the range of short-range data transfer, said distinctive data being thus indicative of the current location-based context of the mobile communications device and the user thereof, and further configured to store said data in the memory, and
a context notification logic (206, 606) configured to transmit an indication of the detected location-based context, such as at least part of said obtained data, to a remote entity, such as a server or another mobile communications device, via the wireless transceiver in order to enable providing, by access to the indication, at least one social contact of the user of the mobile communications device with knowledge of the current context of the mobile communications device and the user thereof.

2. The mobile communications device of claim 1, further comprising a social contact notification logic (602) configured to transmit at least part of the stored social contact information to a remote entity, such as a server.

3. The mobile communications device of claim 1, further configured to receive an indication of a context update of a social contact, said indication sent by a remote entity, such as a server or a mobile communications device of said social contact.

4. The mobile communications device of claim 1, wherein the received data comprises or indicates at least one element selected from the group consisting of: location, temperature, time, tag owner details, message, message by the tag owner, message by a previous user of the tag, message left to one or more social contacts by the user of the tag, a discount code, an address or a link such as a hyperlink, an advertisement, a verification code or a number, expiry time, tag type, context entry, and context exit.

5. The mobile communications device of claim 1, wherein communication with a tag is configured to trigger at least one action selected from the group consisting of: device mode change, user profile change, data transmission, transmission of a data request, transmission of social contact data, a call initiation, data reception, auditory signal reproduction, tactile feedback such as vibratory feedback, visual message reproduction, and business card transmission.

6. The mobile communications device of claim 1, configured to determine context entry and context exit on the basis of two interactions with the same tag, wherein the first interaction is mapped to a context entry and the subsequent interaction to a context exit.

7. The mobile communications device of claim 1, configured to reset a context expiry timer upon obtaining the data from the tag and optionally configured to send a notification of the timer reset or expiration thereof to a remote device.

8. The mobile communications device of claim 1, configured to update its current context to match the context of the mobile communications device of a social contact provided that the context of the mobile communications device of the social contact was or is changed within a predetermined time window relative to the short-range wireless communication between the two mobile communications devices.

9. The mobile communications device of claim 1, configured to program a tag with user-determined information via the short-range wireless transceiver.

10. A server arrangement (232, 332, 344, 348) for enhancing context awareness in social networking between a number of users comprising a processor (450) for processing data, a memory (452, 346) for storing data, and a communications interface (454) for transferring data via a communications network, said arrangement further comprising
a social contact management logic (458, 706) for maintaining, relative to a user, a database of one or more social contacts and corresponding contact information for addressing at least one mobile communications device of the contact in view of data transfer capability, and
a context management logic (458, 708) for obtaining and maintaining context indications provided by a mobile communications device of a user, said indications being based on data distinctive to and provided by a tag disposed in a location accessible by the user of the mobile communications device with the short-range wireless transceiver of the device, said distinctive data being thus indicative of the current location-based context of the close mobile communications device and the user thereof, said context management logic being further arranged to provide at least one entity, such as a social contact of the user of the mobile communications device and/or another server, with knowledge of the current context of the mobile communications device and thereby the user thereof.

11. The server arrangement of claim 10, configured to transmit, in response to obtaining a context indication provided by the mobile communications device of the user, said context indication to one or more devices of one or more social contacts of the user, respectively.

12. The server arrangement of claim 10, configured to send one or more files, such as documents, to the mobile communications device, the one or more files being selected on the basis of and relating to the context indicated.

13. A system comprising a mobile communications device of claim 1, and a number of tags to be disposed in a number of locations, respectively, each tag comprising a short-range wireless transmitter for transmitting data distinctive to and stored by the tag.

14. The system of claim 13, comprising a tag defining a context entry and another tag defining a corresponding context exit.

15. The system of claim 13, further comprising a server arrangement comprising a processor (450) for processing data, a memory (452, 346) for storing data, and a communications interface (454) for transferring data via a communications network, said arrangement further comprising
a social contact management logic (458, 706) for maintaining, relative to a user, a database of one or more social contacts and corresponding contact information for addressing at least one mobile communications device of the contact in view of data transfer capability, and
a context management logic (458, 708) for obtaining and maintaining context indications provided by a mobile communications device of a user, said indications being based on data distinctive to and provided by a tag disposed in a location accessible by the user of the mobile communications device with the short-range wireless transceiver of the device, said distinctive data being thus indicative of the current location-based context of the close mobile communications device and the user thereof, said context management logic being further arranged to provide at least one entity, such as a social contact of the user of the mobile communications device and/or another server, with knowledge of the current context of the mobile communications device and thereby the user thereof.

16. A tag for use with the system of claim 13, comprising a memory for storing data distinctive to the tag, a short-range wireless transmitter for providing at least part of said data to an external entity equipped with a compatible receiver, the tag further comprising a logic to keep track of interactions with a certain mobile communications device such that a first interaction converts to a context entry indication in the provided data and a subsequent interaction converts to a context exit indication therein.

17. A method for enhancing context awareness in social networking by a mobile communications device, comprising
obtaining (804) a mobile communications device comprising a wireless transceiver for wirelessly transmitting and receiving data relative to remote devices, and a short-range wireless transceiver, such as an NFC (near field communication) transceiver, for wirelessly transmitting and receiving data relative to remote devices equipped with a compatible short-range transmitter or transceiver, such as a mobile communications device or a tag, respectively,
establishing (806, 808) a social contact by information received from a mobile communications device of a social contact via the short-range wireless transceiver, said information identifying the social contact and/or the mobile communications device of the social contact,
detecting (810, 812) current context by obtaining, via the short-range wireless transceiver, data distinctive to and stored by a tag disposed in a location accessible by the user of the mobile communications device in light of the range of short-range data transfer, said distinctive data being thus indicative of the current location-based context of the mobile communications device and the user thereof, and
transmitting (814) an indication of the detected location-based context, such as at least part of said obtained data, to a remote entity, such as a server or another mobile communications device, via the wireless transceiver in order to enable providing, by access to said indication, at least one social contact of the user of the mobile communications device with knowledge of the current context of the mobile communications device and the user thereof.

18. A computer program, comprising code means adapted, when run on a computer device such as the mobile communications device obtained in a step of claim 17, to execute the subsequent method steps.

19. A carrier medium comprising the computer program of claim 18.
